(19) United States
(12) Patent Application Publication
(10) Pub. No.: US 2004/0078601 A1
(43) Pub. Date: Apr. 22, 2004

(54) System and method for operating a wireless device network

(76) Inventors: Chris Tengwall, Arnold, MD (US); Chris Rimmel, Columbia, MD (US); Scott Belden, Arnold, MD (US); Eric Harris, Abingdon, MD (US); Kevin Stricklin, Owings Mills, MD (US)

Correspondence Address: KENYON & KENYON, ONE BROADWAY, NEW YORK, NY, 10004, US

(21) Appl. No.: 10/634,223

(22) Filed: Aug. 4, 2003

Related U.S. Application Data
(60) Provisional application No. 60/400,054, filed on Aug. 2, 2002.

(51) Int. Cl. H04L 9/00

(52) U.S. Cl. 713/201

(57) ABSTRACT

A system and method for transmitting data. The system includes a database that stores data. The data is sent to a server for processing. A relay is then used to route the data for transmission. A firewall provides security for the data, the server, and the relay. The data is then sent by the relay to a wireless carrier network. A handheld wireless device receives the data from the wireless carrier network. In the system, the relay is arranged behind the firewall.

### RELATED APPLICATIONS

This application claims the benefit under 35 U.S.C. §119(e) of U.S. provisional application Serial No. 60/400,054, filed Aug. 2, 2002, the contents of which are incorporated herein by reference.

### FIELD OF THE INVENTION

The present invention relates to the operation of wireless handheld computer devices and the networks that the devices utilize. Also, the present invention relates to a scalable, flexible platform that facilitates the secure transfer of data independent of the network originating the data, the network(s) through which the data travels or the device to which the data travels.

### BACKGROUND INFORMATION

Users of wireless handheld devices utilize the devices to maintain connectivity to a computer network. One of the most popular network services to which the wireless devices may provide connectivity is e-mail. Such network services may also include wireless access to calendar/schedule information, address book/contact lists and other personal information (together with e-mail, the identity of systems and systems for management of such information is often denoted as Personal Information Management or Personal Information Manager, respectively, and in general together as PIM). From a computer networking point of view, there are many issues that may arise in providing e-mail services to handheld device users. Such issues may include the manner in which e-mail messages are transmitted, the efficiency of message transmission, the need to run multiple servers within the enterprise's proprietary network infrastructure to allow for enterprise users to carry and use different types of handheld devices or to enable device connectivity through different communications networks, the type and level of network security, and the configuration of the wireless network.

In terms of e-mail transmission, there are known systems that involve packaging data into e-mail messages and that rely on an associated e-mail transport system to deliver the data over the wireline Internet. The vast majority of e-mail users simply want the data to get to a desired recipient without having to specify how their e-mail message will be repackaged and encoded into multiple data packets in a form suitable for electronic transfer to the recipient, or the route the data packets take to get to the desired user. Using a known e-mail transport system accomplishes such transmission. However, these transport systems overhead in terms of having to encode the data into an e-mail message format. However, these transport systems require that each data packet be encoded with information so it may be decoded and reconstituted for viewing as an e-mail after transmission. While this method works, it is not efficient because the encoding information may be thought of as “overhead”. E-mail management and transport systems used today include POP3, IMAP, Microsoft Exchange, and Novell GroupWise and others, and data protocols into which such messages must be encoded include GPRS, IXRTT, IDEN, Mobitex and others.

In terms of the requiring the enterprise to deploy and maintain multiple servers, there are known installations of such arrangements. For example, an enterprise may deploy a Palm Enterprise Server in addition to a Blackberry Enterprise Server so its users may choose to carry a Palm or a Blackberry handheld. In this case, the need to run multiple servers within the enterprise's proprietary network infrastructure to make it possible for the enterprise's users to carry different types of handheld devices or to enable their connection through different communications networks is expensive and complicated to maintain. In respect of PIM information, the enterprise must, for example, tie both the Palm and the Blackberry Enterprise Servers into its installation of Microsoft Exchange. In respect of other information, an enterprise with other data communications needs like wireless access to enterprise information held in enterprise resources planning databases, customer relationship management databases or in other standard databases must be tied into multiple wireless servers as well. Each of these degrees of freedom requires customized programming interfaces, and in most cases, customized data applications on both the client and the server side.

In terms of security, other systems may use known encryption technology to provide security for the network and for e-mail security. Such encryption technology is discussed, for example, in Applied Cryptography, Second Edition, Bruce Schneier, John Wiley & Sons, 1996. One issue that arises in the use of wireless handheld devices is that the wireless device must be cradled (inserted) into a wired connection device that is attached to a personal computer in order to update the device with operational data and software, e.g., encryption data and encryption keys, that the computer has received via the wireline Internet or an intranet. Security is a critical issue in light of the needs of particular users such as, for example, United States government agencies and in light of Federal standards such as the Federal Information Processing Standards Publication (FIPS PUB 140-2), National Institute of Standards and Technology, May 25, 2001.

In terms of network configuration, a relay may be included as a network component. The relay acts as an entrance to another network. The relay includes software that knows where to direct a given data packet that arrives at the relay (similar to a router), and it furnishes the actual path in and out of the relay for a given data packet (similar to a switch). The data packet may include e-mail data. For example, a data packet may be any set of data. Wireless e-mail solutions such as BlackBerry from Research in Motion (RIM) and GoodLink from Good Technologies use a relay to send data, e.g., e-mail or other PIM, back and forth between a server and wireless carriers. Such systems use relays that are installed in a centralized data center. The location and control of the centralized data center may present security risks for those looking to ensure highly secure transmissions. For example, the centralized data center may be located in a foreign local presenting national security risks. Also, a particular customer has neither control over the physical security at the centralized data center nor control over the configuration of the data center, e.g., the use of appropriate backups systems.

### SUMMARY

The system and method of the present invention is for transmitting data. The system includes a database for storing data and a server for processing data. Also, the system includes a relay that encodes, routes, and transmits the data. A firewall, in this instance, provides security for the data, the database, the server, the relay, and all other private network components. The firewall protects these private systems from external threat and “hackers”. In other exemplary embodiments, the enterprise may use a dedicated wireline communication line to send data between the relay and the wireless carrier network. The server and relay may be arranged on a single physical device or on multiple physical devices. In the system of the present invention, the relay is arranged within the confines of the enterprise proprietary network infrastructure, e.g., behind the firewall. The data is then sent by the relay to a wireless carrier network. A direct connection with at least one wireless carrier network is preferred. Also, the connection with the wireless carrier network may be a non-direct connection. A handheld wireless device may then be used to receive the data from at least one wireless carrier network. In the present system, the data may include e-mail data, other PIM data, and/or other enterprise information. Also in the method of the present invention, the handheld wireless device may receive data related to encryption including, e.g., an updated PIN, access code, etc. without being cradled in a connection device. The handheld wireless device may also include software and/or hardware for processing data received from, and sent to, the wireless carrier network. Furthermore, the system may include at least one backup database, at least one backup server, and at least one backup relay for purposes of system redundancy. The backup server and the backup relay may be located in the same location or a different geographic location than the server and the relay. Also, the backup server and the backup relay may be connected to a different power grid and may have different connections to at least one wireless carrier network.

### BRIEF DESCRIPTION OF THE DRAWINGS

FIG. 1 shows a known system.

FIG. 2 shows an exemplary embodiment of the system according to the present invention.

FIG. 3 shows another exemplary embodiment of the system according to the present invention.

FIG. 4 shows an exemplary embodiment of the method according to the present invention.

### DETAILED DESCRIPTION

The system and method according to the present invention provide an open platform for a wireless transport network supporting multiple handheld device types. The wireless transport network may securely exchange enterprise data, e.g., e-mail, other PIM information, and other data, through a proprietary connection (direct and dedicated connection) or a nonproprietary connection to one or more wireless carriers. The system and the method of the present invention provide for a scalable, flexible platform that facilitates the transfer of data that is independent of the data communications network on which the data is transmitted or the type of handheld device to which the data travels. For example, using the system and method of the present invention, data packets may be transmitted on wireless communications networks with different transmission protocols, and may be sent and received to and from a variety of wireless handheld devices running different operating systems.

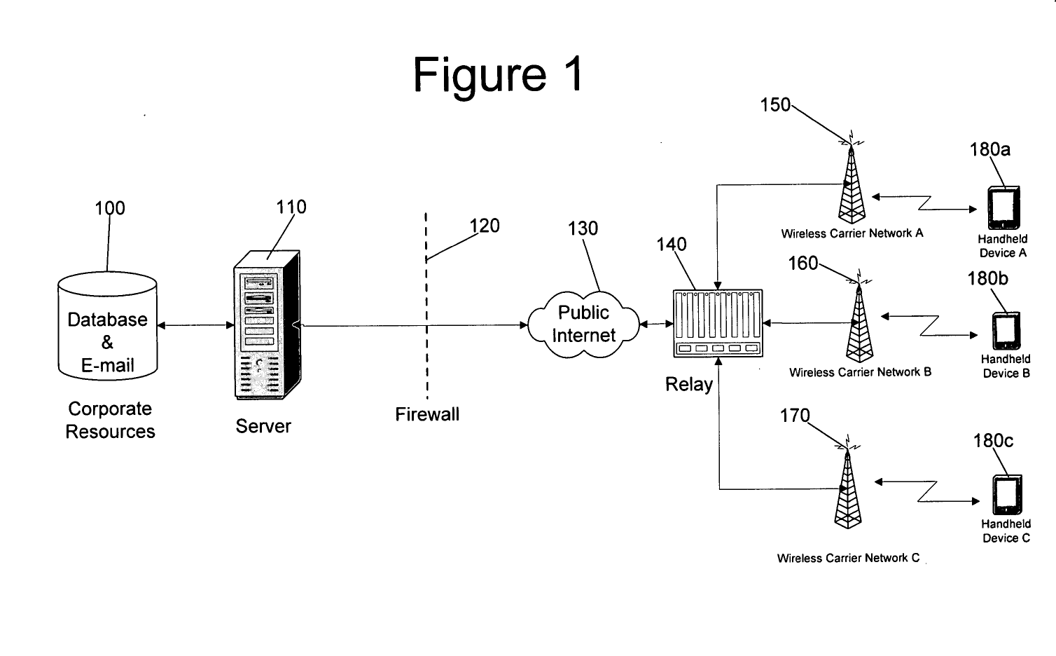

FIG. 1 shows a known wireless data system. E-mail and other data is generated and stored in database 100. The data and e-mail is generated by an enterprise (company, agency, institution, etc.) and represents corporate resources (knowledge and/or information). The database 100 may include a Microsoft Exchange server, a Lotus e-mail server, or like arrangement. To transmit the data and e-mail, a server 110 obtains the data from the database 100. The server 110 of the enterprise processes the data and sends the data through a firewall 120. The firewall 120 of the enterprise includes hardware and/or software that provide security for data on the server 110 and the database 100. The data is packaged in a format compatible for transmission over the public Internet 130 and then sent via the Internet 130 to a relay 140. The data may also be transmitted over any type of network. Data is routed by the relay 140 for delivery to an end user. The relay 140 is located at a centralized data center that outside of the physical control of the enterprise and the enterprise's electronic information security systems. The data is transmitted by the relay 140 to at least one wireless carrier network 150, 160, or 170. Then the wireless carrier network 150, 160, and 170 processes and transmits the data to one handheld device 180a, 180b, or 180c. Software applications and hardware is included in the handheld device 180a, 180b, or 180c for interpreting the data and parsing out the incoming data to various device applications. Of course, the transmission of data in the direction originating from the handheld device 180a, 180b, or 180c is also possible.

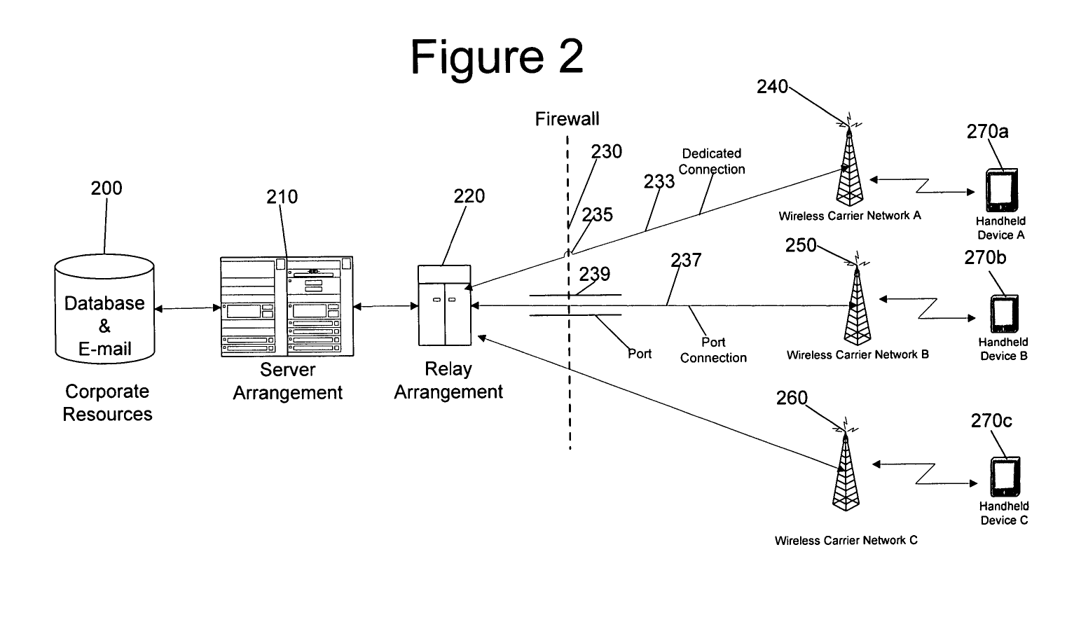

FIG. 2 shows an exemplary embodiment of a system according to the present invention. E-mail, PIM data, and other data is generated and stored in database 200. There may be multiple databases containing different information and generating and storing e-mail, PIM data, and other data. The data and e-mail is generated by an enterprise (company) and represents corporate resources (knowledge). The database 200 may include a Microsoft Exchange server, a Lotus E-mail server, other known e-mail servers, SQL server databases, Oracle database applications and mainframe systems, or a like arrangement. To transmit the data and e-mail, a server arrangement 210 obtains the data from the database 200. The server arrangement 210 of the enterprise processes the data, e.g., it packages and encrypts the data into the format that is most efficient for the relay arrangement 220 to receive, and sends the data to a relay arrangement 220.

An example of the server arrangement 210 is the Extensia Server from LRW Digital, Inc. Encryption may be provided, for example, via use of Certicom's FIPS 140-2 certified crypto-modules. For example, crypto-modules may include triple-DES and AES. Software and hardware is included on the relay arrangement 220 for routing the e-mail and the data. An example of the relay arrangement 220 is the Extensia Relay/Switch from LRW Digital Inc.

The data is then sent through a firewall arrangement 230 to at least one wireless carrier network 240, 250, or 260. Firewall is a general term that represents the last line of defense for an enterprise against unwanted unauthorized entry into its proprietary systems. The firewall arrangement 230 includes hardware and/or software that provide security for data on the relay arrangement 220, the server arrangement 210, and the database 200, as well as to all enterprise network components that may be accessed therethrough.

Enterprises with extremely high security needs may choose to have their wireline telecommunications carrier install a direct, proprietary connection 233 between their relay arrangement 220 and at least one wireless carrier network 240, 250, or 260. In this case, the enterprise's firewall arrangement 230 does not mediate the transmission of data to or from the relay arrangement 220 and the wireless carrier networks 240, 250, and 260. In FIG. 2, the bypass of the firewall via the direct, proprietary connection 233 is indicated by 235. Hence, according to the present invention, the transmission of data from the relay arrangement 220 to the wireless carrier network 240, 250 or 260 may be accomplished through at least one dedicated line 233 between the relay arrangement 220 and the wireless carrier networks 240, 250, or 260.

Enterprises with lesser security needs, may create a designated port 239 within the firewall arrangement 230 that permits traffic associated with the applications on server arrangement 210 and relay arrangement 220 to pass through via a port connection 237.

In other exemplary embodiments of the present invention, the transmission of data from the relay arrangement 220 to the wireless carrier network 240, 250 or 260 may be accomplished through at least one dedicated connection line 233 between the relay arrangement 220 and the wireless carrier networks 240, 250, or 260. The use of dedicated lines may be preferred to ensure greater security, however known security measures may be used within other exemplary embodiments of the present invention. In using a dedicated connection line 233, the data passes through and/or bypasses the firewall arrangement 230 such that the firewall arrangement 230 is not involved in processing nor handling the data in any manner (235 indicates the bypass of data). The dedicated connection 233 may include a frame relay connection, a Ti connection or any other type of dedicated connection method or system. Also, when not using a dedicated line, the data may be processed by the firewall arrangement 230 to the extent that a transmission port 239 is opened by the firewall for sending the data. Use of the port 239 in the firewall arrangement 230 establishes a port connection 237. A connection to the Internet may be established via use of the port connection 237 for sending the data.

Then, either by a direct, proprietary physical connection (dedicated connection) 233 or through a designated port 239 in the enterprise's firewall, the data is sent to at least one wireless carrier network 240, 250, or 260. The wireless carrier network 240, 250, and 260 then processes and transmits the data to at least one handheld device 270a, 270b, or 270c that receives at least one data packet from the relay arrangement 220. Software applications and hardware are included in the handheld device 270a, 270b, or 270c that interact with the relay arrangement 220, interpret the received data and parse out the incoming data to various device applications. Thus, the system according to the present invention provides that data packets may be sent to an end user without traveling through the Internet, a relay outside of the control of the enterprise, and/or a common relay outside of the control of the enterprise. Also, the system of the present invention provides that the data packets may be transmitted to the wireless carrier network 240, 250 or 260 via the public Internet (using port 239 and port connection 237) or via a direct and proprietary (dedicated) connection 233.

Other systems, such as in FIG. 1, use relays that are installed in a centralized data center. The centralized data centers may be controlled by an outside party and may be located in a foreign country thus presenting the potential for security risks for the network and the data. The data center in which other systems place their common relay 140 may also be at great physical distance from the enterprise, requiring transmitted information to travel much farther than is truly required to gain access to a wireless network carrier 150, 160 and 170. This is inefficient and increases the chances of packet latency and packet loss. In other systems, data is sent to the centralized relay 140 (see FIG. 1) and resides there until the relay 140 notes that the intended recipient's handheld device has registered on the relay through the appropriate wireless carrier network. This pending transmission (e.g., e-mail) may be stored and persist before and after delivery to a handheld device user. The data may be held at the relay 140 for a significant period of time and the shared relay 140 is outside of the enterprise's firewall and therefore outside of the enterprise's control.

With the system according to the present invention shown in FIG. 2, the relay arrangement 220 is installed within the enterprise's proprietary network infrastructure and is arranged behind the firewall 230. With this configuration, the enterprise does not have to worry about data persisting on a shared outside relay. Furthermore, having the relay arrangement 220 behind the firewall may allow for an enterprise to install a direct and secure connection between its own firewall 230 and a wireless carrier network 240, 250, 260, avoiding the public Internet and associated security risks. The relay arrangement 220 allows the enterprise to connect directly to one or more wireless carriers 240, 250, 260 using secure, private connections such as a frame relay connection, thereby avoiding the public Internet all together. Other systems, as shown in FIG. 1, use the public Internet 130 for carriage from the enterprise firewall 120 to the relay 140. In the system of FIG. 1, data travels over the public Internet 130 between the enterprise and the shared relay 140. In the event of a denial of service attack or some other incident that impairs the flow of data on the Internet, all wireless e-mail traffic would be impacted. With many Federal agencies using wireless e-mail as the manner of communications for their continuity of operations plans, a denial-of service-attack coupled with a terrorist attack may severely impair emergency response coordination or make it altogether impossible.

In FIG. 2, relay arrangement 220 sits (is arranged) between a server arrangement 210 and various wireless carrier networks 240, 250 or 260. The relay arrangement 220 handles the routing and switching of data between the server arrangement 210 and the wireless carrier networks 240, 250 or 260. The relay arrangement 220 also executes the back-and-forth conversions between a data packet protocol according to the present invention and various protocols associated with each wireless carrier network, e.g., Mobitex's MPAK. Accordingly, the relay arrangement 220 is programmed to communicate with any wireless carrier network in a manner that is transparent to the database 200 or the server arrangement 210. Data, including e-mail, PIM information and other data may be prepared, encoded and encrypted and sent either directly through port 239 in firewall 230 via port connection 237 or via dedicated connection 233 to the wireless carrier 240, 250, or 260 for delivery to the device 270a, 270b or 270c without using a relay outside of the firewall 230 or sharing the relay with any other enterprises. In the present exemplary embodiment, the relay 220 is within the exclusive control and domain of the enterprise, and no other enterprise's data moves through or resides on the relay 220. Hence, the system according to the present invention provides for the relay arrangement 220 to be controlled by the enterprise, not an outside party, and the relay 220 may be arranged (installed) behind a firewall 230 in the enterprise's data center and network.

Arranging the relay arrangement 220 behind the firewall arrangement 230 may allow an enterprise to construct a direct connection to any or all of wireless carrier networks 240, 250, or 260 and for increased end-to-end security for the system and data. A critical issue with the system shown in FIG. 1 is that the data to be transmitted to the centralized relay 140 is sent out from the server arrangement 110 whether or not the intended wireless carrier 150, 160 or 170 is “in service” and whether or not the intended recipient handheld device 180a, 180b or 180c is “on” and within the carrier's service coverage area. This means that the data resides and persists on the relay 140 until the wireless carrier network and the handheld device are both able to accept it. For a variety of reasons, service outages occur and it is well accepted that wireless carrier coverage extent and quality may vary. Enterprises deploying the system of FIG. 1 must therefore accept this critical issue. In the present invention shown in FIG. 2, the data to be transmitted is not sent beyond the exclusive security and domain of the enterprise until the wireless carrier's network 240, 250, 260 is “up” and the intended recipient's handheld 270a, 270b. 270c is “on”, is within a service coverage area, and is logged onto the wireless carrier's network 240, 250, 260.

Additionally, the arrangement of the relay arrangement 220 behind the firewall allows the system in FIG. 2 to avoid, in that arrangement, transmitting sensitive data over the public Internet. The system in FIG. 1 includes a relay 140 that is centralized and remote and that is vulnerable to denial-of-service attacks during which data packets may be lost or delayed. Also, with the relay arrangement 220 behind the firewall 230, the enterprise using the system has complete control over all elements of their wireless system except for the wireless carriers 240, 250, 260. The enterprise may readily monitor the performance of the relay arrangement 220 and the connections to the wireless carrier networks 240, 250, 260. In other systems, as shown in FIG. 1, the relay 140 is centralized and remote, and the relay 140 is a shared resource through which all e-mail traffic is concentrated. If this shared resource encounters any performance issue it may not be identified, addressed or controlled by the enterprise.

As mentioned earlier, the relay arrangement 220 in the present invention may include a combination of software modules that provide data to a variety of devices over a variety of networks. A software module includes software in executable form that performs a specific function or a group of related functions and adheres to a particular interface. Generally a software module may be in a DLL file or EXE file. Two or more software modules may reside in a single DLL file or EXE file. The relay arrangement 220 may include an executable application (EXE) with zero or more supporting DLLs.

The relay arrangement 220 according to the present invention may include transport engines and the service engines. The relay arrangement routes data from any service engine to any transport engine. Transport engines include software modules that accept a data packet from the relay arrangement and deliver it to the receiving device. The software modules of a transport engine provide one or more functions that handle the details of transporting data packets over various networking technologies. A transport engine, for example, may have to segment the data packet for delivery. Transport engines provide an interface between the relay arrangement 220 and the database 200 and the server arrangement 210 of the enterprise. Transport engines may include software that formats the data to be sent via the appropriate transport protocol. Transport engines allow for the transmission of data packets via various protocols. In turn, using a transport engine any wireless carrier network 240, 250, or 260 communicates with the relay arrangement 220. For example, wireless carrier network 240, 250 or 260 may employ Mobitex, Motient, IXRTT, and GPRS communications methodologies. Service engines include software modules that provide data or use data. The software modules of a service engine provide one or more functions that handle the details of transporting data packets over various networking technologies. Service engines send and receive data via the relay arrangement. Service engines provide an interface between the relay arrangement 220 and enterprise data stored on a database 200. Service engines may include software that processes data into information that is understandable to the end user of the handheld device. The Service engines provide the end user the information needed on the device 270a, 270b, or 270c while out in the field. An example of a service engine is a data exchange service that provides e-mail, contact, and calendar data. Another example of a service engine is a remote monitor service. Once a service engine is created it may work with any transport engine.

The system according to the present invention provides that deletion of e-mail may be performed on both the handheld device 270a, 270b, or 270c and the e-mail database 200. This provides synchronous e-mail management and deletion. Other systems only allow a user to delete e-mail messages at the handheld device, such that the e-mail message may remain in the e-mail database to be deleted from the e-mail database at a later time.

The system according to the present invention provides that encryption data, e.g., encryption keys, may be updated on the handheld device 270a, 270b, or 270c without cradling of the handheld device 270a, 270b, or 270c. Other data and operational information relating to the functionality of the handheld device 270a, 270b, or 270c may also be updated without cradling. Other systems may require frequent device cradling to regenerate an encryption key. If the encryption key is not regenerated and updated, communications may be disabled. The ability to update data on the handheld device 270a, 270b, or 270c with cradling may be critical to a highly mobile workforce with limited access to desktops PCs and may reduce the need and the cost associated with desktop PCs that connect the cradling device to the network.

The problem of updating security information wirelessly, without cradling the device 270a, 270b, or 270c, is twofold. First, the process of creating security keys is CPU intensive. The relatively low powered CPUs in wireless handheld devices 270a, 270b, or 270c are slow in terms of creating new encryption key data. Creating key data on demand involves heavy use of CPU resources, and as a result the device may stop responding to user requests for several minutes. Secondly, once new encryption key data is formed, some portion of it must be securely transported to the host server 210. The first issue of CPU resources may be addressed by creating encryption key data during idle periods of device usage. While the process of generating encryption key data continues to use many CPU cycles, the end-user experience isn't impacted. The second issue of securely transporting the encryption data key may be addressed by generating new encryption key data before the existing encryption key data expires. While using an existing secure connection, the appropriate new encryption key data is transmitted to the host server 210. At a coordinated time, both the host server 210 and device 270a, 270b, or 270c start using the newly created encryption key data. Use of encryption technology and updating the encryption key may allow for secure transfer of data. In the system according to the present invention, end-to-end security may be provided for via use of the triple DES data encryption standard.

The system according to the present invention includes an Application Programming Interface (API). The API includes a data packet protocol that encapsulates data with routing and transport information. The format of the data will likely be determined by the applications sending the data. The data packet protocol may include an Extensible

Markup Language (XML) format. Using this data packet protocol, developers may be able to package data, without the need to encode it, and hand it to the system according to the present invention for delivery. The data packet protocol provides a common format for all data handled by the system according to the present invention. The data packet protocol includes two basic parts, a header and a payload. The system according to the present invention uses data in the header of the data packet to transport the data. The relay arrangement 220 uses the header data in routing the data packet within the system of the present invention. Also, the data packet protocol includes a payload. The payload includes the data that a developer desires to send. Furthermore, the data packet protocol is configured such that the header results in minimal overhead and still provides sufficient data to route data. This data packet protocol provides that the data in the payload is transparent to the system of the present invention and that the data arrives at its destination unmodified. The type of data, or the format of the data, does not affect the ability to transmit the data via the system according to the present invention.

Furthermore, the API and the data packet protocol may allow developers to create a single application that may be used on various “push” platforms. In turn, each application category may establish its own format for the payload of the data packet structure. For example, all e-mail applications are in a common category and share a common payload format. Hence, the API and the data packet protocol provide that an e-mail service may be written and integrated into a specific e-mail platform. E-mails may then be sent to any supported device/network platform. As new devices are supported, the system according to the present invention, without modification, may work with them. Additionally, a new e-mail service could be written supporting a different platform and the handheld device would work with it without modification. In turn, customer applications may be created by outside parties. Customer applications include customer designed service engines. The customer applications utilize the API according to the present invention to communicate with any type of wireless device.

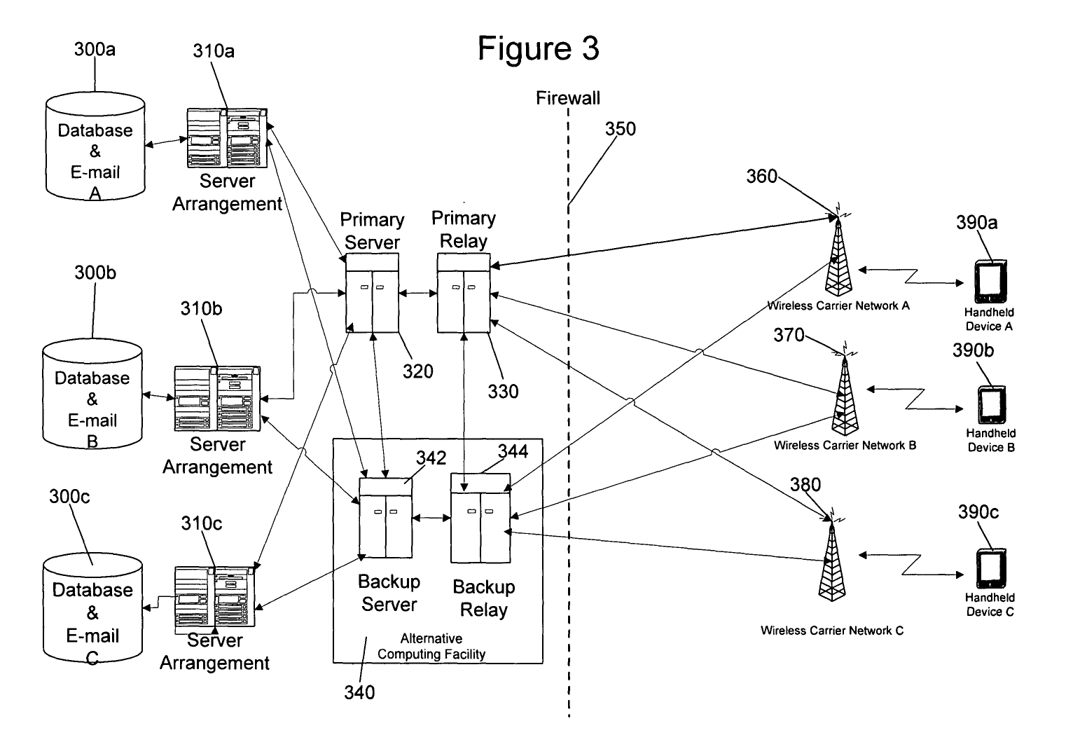

In FIG. 1, messages are sent to a centralized relay 140 and thus take on the risk of a single point of failure. The centralized relay 140 may be located in a foreign country and may store the data for transmission thus presenting national security issues and concerns for government users. While the system in FIG. 1 may have some level of redundancy, relay outages have occurred many times in the past and will more than likely occur in the future. In addition, the shared relay 140 is located in a single geographic location and are vulnerable to natural disasters, terrorist attacks and/or accidents such as cable cuts and fires. The server 110 and the relay 140 are single points of failure that, when not operating properly, impair communications. To address such issues, an enterprise may use a system as shown in FIG. 3 to create its own backup relay behind its own firewall, making it possible to create an almost completely redundant wireless communications system. The wireless carrier's network 360, 370, or 380 is the only element that an enterprise may not duplicate. Not only is the primary relay arrangement 330 arranged behind the firewall 350, it may also be arranged in a highly available, redundant architecture that may allow for automatic failover in case the primary relay arrangement 330 fails. Also, a backup relay 344 may be installed in a different geographic location thereby reducing its vulnerability even further. This redundancy is important for e-mail and other communications, but it is potentially even more important for pure data applications that connect into core data systems, e.g., for the FBI, a terrorism bulletin.

The exemplary embodiment of the present invention shown in FIG. 3 functions in a similar manner to the system shown in FIG. 2. Redundant e-mail databases 300a, 300b, and 300c are used to generate and store e-mail and data. The data and e-mail is generated by an enterprise (company) and represents corporate resources (knowledge). To transmit the data and e-mail, redundant server arrangements 310a, 310b, and 310c obtain the data from the databases 300a, 300b, and 300c. The redundant server arrangements 310a, 310b and 310c of the enterprise process the data and send data to a primary relay arrangement 320. A primary relay 330 is used to route the data and send it through the firewall 350. The data is then sent through the firewall 350 to a wireless carrier network 360, 370 or 380. The wireless carrier network 360, 370, and 380 then processes and transmits the data to at least one handheld device 390a, 390b, or 390c. In the event that the primary server 320 and the primary relay 330 are not operating properly, an alternative computing facility 340 may be used to send the data. The alternative computing facility 340 includes at least one backup server 342 and at least one backup relay 344 for transmitting the data. By providing redundant databases 300a, 300b, 300c, redundant server arrangement 310a, 310b, 310c, a backup server 342, and backup relay 344 eliminates single points of failure as in the system shown in FIG. 1.

The systems in FIG. 2 and FIG. 3 may also be configured such that the relay arrangement 220, 330, or 344 is arranged within a network that is completely, controlled and operated by the enterprise. Hence, the relay arrangement 220 is under the exclusive domain and control of a single enterprise. Furthermore, the enterprise network may be rather extensive in terms of size and resources that the system according to the present invention, including the carrier networks 240, 250, 260, 360, 370 or 380, operates within the controlled boundaries of the enterprise's network.

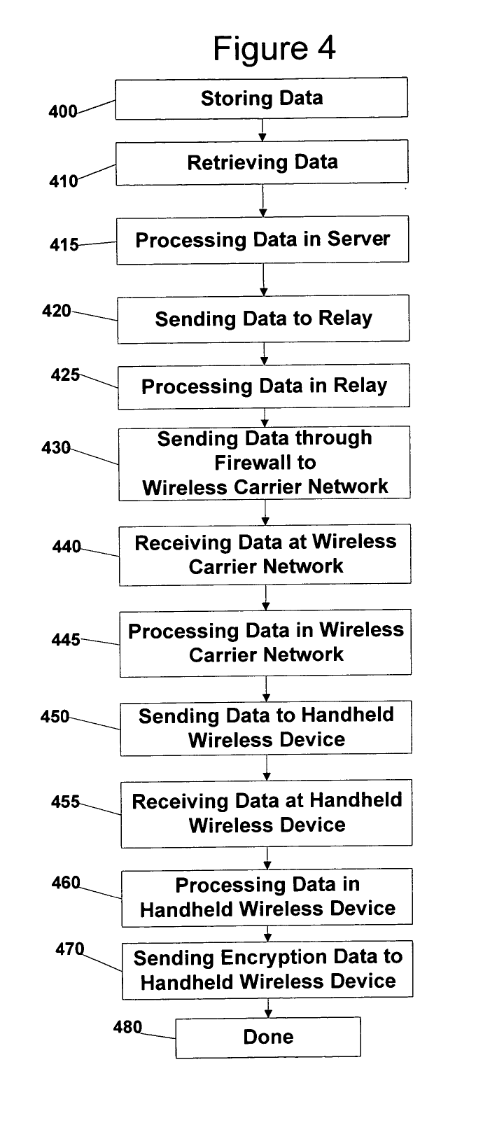

FIG. 4 shows an exemplary embodiment of the method according to the present invention. The method according to the present invention is used to transmit data in the system according to the present invention as described above in reference to FIG. 2. In FIG. 4, data is stored in step 400. Then in step 410, the server 210 retrieves (pulls) the data from the database (see FIG. 2). Data is retrieved from the database via the server arrangement 210. In step 415, the data is processed in the server 210 (see FIG. 2). Then in step 420, data is sent to a relay 220 (see FIG. 2). In step 425, the data is processed and routed in the relay 220 (see FIG. 2). The data is routed to at least one wireless carrier network 240, 250, or 260 (see FIG. 2). In step 430, the data is sent through a firewall arrangement 230 (see FIG. 2) to the at least one wireless carrier network 240, 250, 260 (see FIG. 2). The firewall arrangement 230 (see FIG. 2) provides security for the data, the server arrangement 210 (see FIG. 2) and the relay arrangement 220 (see FIG. 2). Then in step 440, the data is received at the at least one wireless carrier network 240, 250, or 260 (see FIG. 2). In step 445, the data is processed in the at least one wireless carrier network 240, 250, 260 (see FIG. 2). Then in step 450, the data is sent to at least one handheld wireless device 270a, 270b, 270b (see FIG. 2). Then in step 455, the data is received at the at least one handheld wireless device 270a, 270b, or 270b (see FIG. 2). In step 460, the data is processed in the handheld wireless device 270a, 270b, or 270b (see FIG. 2). Then in step 470, encryption data is sent to the handheld wireless device 270a, 270b, 270b (see FIG. 2) via a wireless transmission connection, thus updating operational capabilities of the handheld wireless device. The wireless transmission connection is described above in reference to FIG. 2. In step 480, the method according to the present invention is done and the method ends.

What is claimed is:

1. A system for transmitting data stored in at least one database and processed by a server arrangement to at least one handheld wireless device that receives data from a wireless carrier network including:
a relay arrangement for routing the data for transmission; and
a firewall arrangement that provides security for the data, the server arrangement, and the relay arrangement;
wherein the relay arrangement being arranged behind the firewall arrangement.

2. The system of claim 1, wherein the data includes at least one of e-mail data and PIM data.

3. The system of claim 1, wherein the at least one handheld wireless device receives encryption data wirelessly.

4. The system of claim 1, wherein the database includes at least one of an e-mail server and a database server.

5. The system of claim 1, further comprising:
a redundant server arrangement for the server arrangement.

6. The system of claim 1, further comprising:
a redundant relay arrangement for the relay arrangement.

7. The system of claim 5, wherein the redundant server arrangement is located in at least one of a same geographic location and a different geographic location than the server arrangement.

8. The system of claim 6, wherein the redundant relay arrangement is located in at least one of a same geographic location and a different geographic location than the relay arrangement.

9. The system of claim 1, wherein the data is encrypted.

10. A method for transmitting data, comprising the steps of:
storing data in a database;
retrieving the data from the database via a server arrangement;
processing the data in the server arrangement;
sending the data to a relay arrangement;
processing the data in the relay arrangement and routing the data to at least one wireless carrier network;
sending the data through a firewall arrangement to the at least one wireless carrier network, the firewall arrangement providing security for the data, the server arrangement and the relay arrangement;
receiving the data at the wireless carrier network;
processing the data in the at least one wireless carrier network;
sending the data to at least one handheld wireless device;
receiving the data at the at least one handheld wireless device;
processing the data in the handheld wireless device;
wherein the relay arrangement being arranged behind the firewall arrangement.

11. The method of claim 8, wherein the data includes at least one of e-mail data and PIM data.

12. The method of claim 8, further comprising the step of:
sending encryption data to the handheld wireless device via a wireless connection, thus updating operational capabilities of the handheld wireless device.

13. The method of claim 8, wherein the data is encrypted.

14. An apparatus for transmitting data, comprising:
means for storing data;
means for processing the data obtained from the means for storing data;
means for routing the data for transmission;
means for securing the data, the means for processing, and the means for routing;
wireless carrier network means for receiving and transmitting at least the data from the means for routing; and
at least one handheld wireless device that receives data from the wireless carrier network means;
wherein the means for routing is arranged behind the means for securing.

15. A system for transmitting data stored in at least one database and processed by a server arrangement to at least one handheld wireless device that receives data from a wireless carrier network including:
a relay arrangement for routing the data for transmission, the relay arrangement being arranged within a controlled network.
